(19) United States
(12) Patent Application Publication
(10) Pub. No.: US 2003/0219304 A1
(43) Pub. Date: Nov. 27, 2003

(54) Retaining device for shaft

(76) Inventors: Chin-Hung Chang, Tu-Chen (TW); Yu-Cheng Chou, Tu-Chen (TW)

Correspondence Address: WEI TE CHUNG, FOXCONN INTERNATIONAL, INC., 1650 MEMOREX DRIVE, SANTA CLARA, CA, 95050, US

(21) Appl. No.: 10/194,534

(22) Filed: Jul. 12, 2002

(30) Foreign Application Priority Data
May 24, 2002 (TW) 91207525

(51) Int. Cl. B25G 3/00; F16G 11/00

(52) U.S. Cl. 403/317

(57) ABSTRACT

A retaining device (10) includes a shaft (12), and a fastener (30) attached to an end of the shaft. The shaft comprises a guide portion (14) at an end thereof for guiding the shaft to enter the fastener. An annular groove (16) is defined in a bottom portion of the shaft above the guide portion. The fastener is bent from a single strip of stainless steel material. The fastener is generally an equilateral triangle, and includes three straight sides (31, 32, 33). Two U-shaped resilient portions (34) are respectively formed at two junctions of the sides. A first end portion (35) extends from a free end of one of the sides. A second end portion (36) extends from a free end of another of the sides, parallel to and closely opposing the first end portion. The fastener is snappingly and securely received in the groove of the shaft.

### BACKGROUND OF THE INVENTION

1. Field of the Invention

The present invention relates to a retaining device for a shaft, and particularly to a retaining device that prevents a motor shaft from escaping from a bearing.

2. Description of the Prior Art

A conventional motor includes a shaft fixed in a rotor and received in a bearing. As the shaft rotates, centrifugal forces are prone to cause the rotor to escape from the bearing. Therefore a groove is typically defined in an end of the shaft that is received in the bearing. A fastener is fitted in the groove to thereby lock the shaft in the bearing. Referring to FIGS. 6 and 7, a shaft 72 is fixedly connected with a rotor 73, and is then inserted into a hole 75 of a bearing 74. The shaft 72 defines a groove 76 at a distal end thereof. A metal retaining ring 80 comprises a cutout such that it is an incomplete ring. The retaining ring 80 is resiliently deformed such that it surrounds the groove 76. The retaining ring 80 is then squeezed by a tool such as a vice to form a substantially continuous ring. Thus the retaining ring 80 is securely received in the groove 76. The retaining ring 80 is then snapped between an end of the bearing 74 and a bearing sleeve 78. Thus, the shaft 72 is prevented from escaping from the bearing 74 during normal rotation of the rotor 73. However, a vice or similar tool is needed to secure the retaining ring 80 to the shaft 72. This makes assembly of the motor unduly complicated. In mass production facilities, efficiency is reduced and costs are unduly inflated.

To overcome the above-mentioned shortcomings, another kind of retaining device has been developed. The retaining device is substantially an annular disc formed from a kind of resilient metalloid material such as Poly (ethylene terephthalate). In assembly, a shaft is inserted into a circular opening of the retaining device. The retaining device is resiliently locked in a groove of the shaft. Unfortunately, the metalloid material limits the efficacy of the retaining device. In particular, the retaining device has low strength, and low resistance to climatic and chemical degradation.

### SUMMARY OF THE INVENTION

Accordingly, an object of the present invention is to provide a retaining device having simple structure.

Another object of the present invention is to provide a retaining device which is easily assembled and used.

A further object of the present invention is to provide a retaining device which is durable.

To achieve the above-mentioned objects, a retaining device of a preferred embodiment of the present invention includes a shaft and a fastener attached to an end of the shaft. The shaft comprises a guide portion at an end thereof for guiding the shaft to enter the fastener. An annular groove is defined in a bottom portion of the shaft above the guide portion. The fastener is bent from a single strip of stainless steel material. The fastener is generally an equilateral triangle, and includes three straight sides. A U-shaped resilient portion is formed at a junction of a first straight side and a third straight side. Another U-shaped resilient portion is formed at a junction of a second straight side and the third straight side. A first end portion extends from a free end of the first straight side. A second end portion extends from a free end of the second straight side, parallel to and closely opposing the first end portion. A diameter of a largest imaginary circle that can be drawn inside the fastener is less than a diameter of a main portion of the shaft, but greater than a diameter of the shaft at the groove. Thus the fastener is snappingly and securely received in the groove of the shaft.

Other objects, advantages and novel features of the present invention will become more apparent from the following detailed description when taken in conjunction with the accompanying drawings, in which:

### BRIEF DESCRIPTION OF THE DRAWINGS

FIG. 1 is an assembled isometric view of a retaining device in accordance with a preferred embodiment of the present invention;

FIG. 2 is a top plan view of a fastener of the retaining device of FIG. 1;

FIG. 3 is an exploded isometric view of the retaining device of FIG. 1 and a motor;

FIG. 4 is a cross-sectional view of the retaining device and motor of FIG. 3 fully assembled;

FIG. 5 is an enlarged view of a circled portion V of FIG. 4;

FIG. 6 is a cross-sectional view of a conventional motor; and

FIG. 7 is a perspective view of a conventional retaining ring.

### DETAILED DESCRIPTION OF THE INVENTION

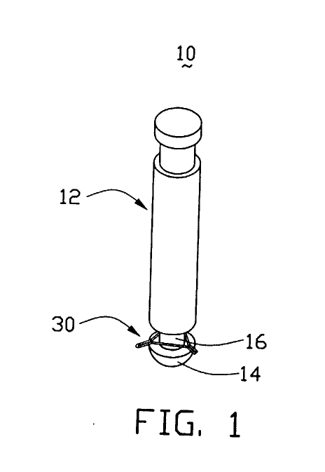

Referring to FIG. 1, a retaining device 10 in accordance with a preferred embodiment of the present invention includes a shaft 12, and a fastener 30 attached to an end of the shaft 12. The shaft 12 comprises a hemispherical guide portion 14 at a bottom end thereof, for guiding the shaft 12 to enter the fastener 30. An annular groove 16 is defined in a bottom portion of the shaft 12 above the guide portion 14.

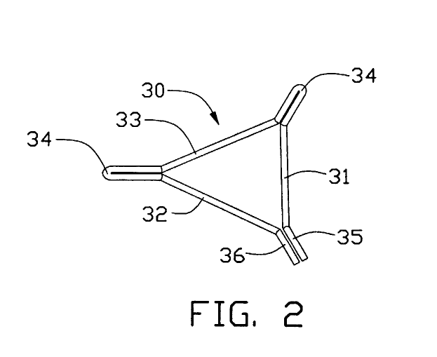

Referring also to FIG. 2, the fastener 30 is bent from a single strip of stainless steel material that has a circular cross section. The fastener 30 is generally an equilateral triangle, and includes three straight sides 31, 32, 33. A U-shaped resilient portion 34 is formed at a junction of the sides 31, 33. Another U-shaped resilient portion 34 is formed at a junction of the sides 32, 33. Each U-shaped resilient portion 34 comprises a narrow slot (not labeled), for providing resilience for the fastener 30. A short end portion 35 extends from a free end of the side 31. A short end portion 36 extends from a free end of the side 32, parallel to and closely opposing the end portion 35. The short end portions 35, 36 extend in a direction substantially perpendicular to the side 33. A diameter of a largest imaginary circle that can be drawn inside the fastener 30 is less than a diameter of a main portion of the shaft 12, but greater than a diameter of the shaft 12 at the groove 16.

It is to be understood that, in alternative embodiments of the present invention, the fastener 30 may instead be polygonal. That is, the fastener 30 may instead comprise four or more straight sides.

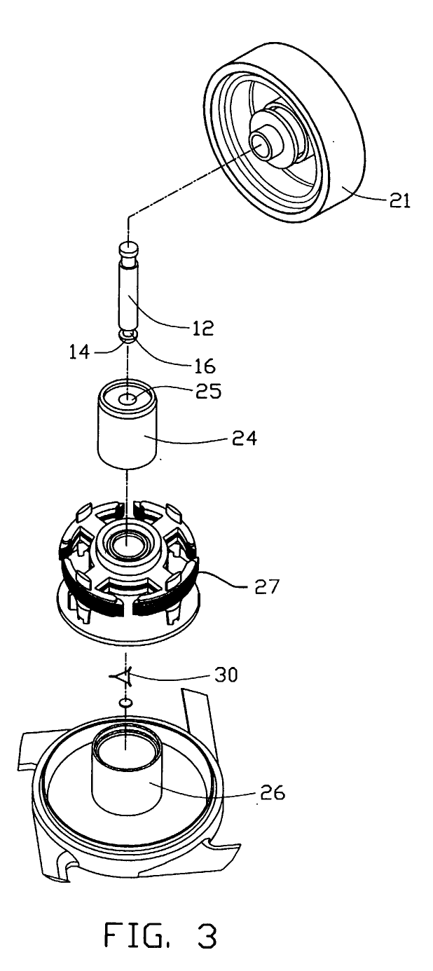

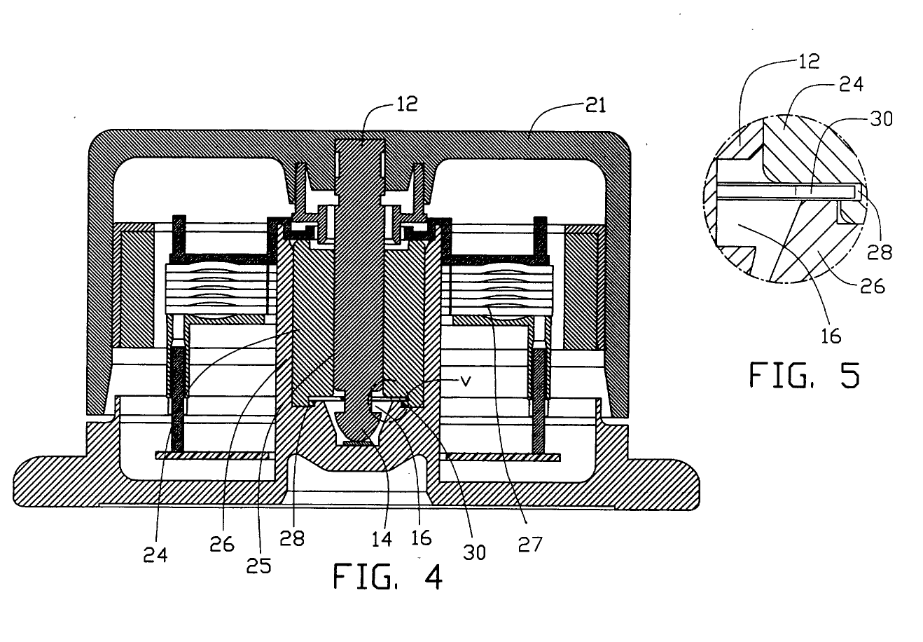

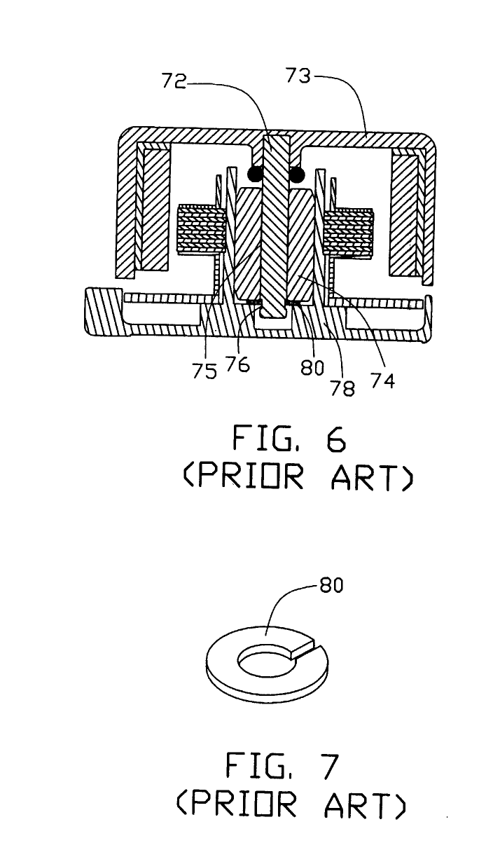

Referring to FIGS. 3-5, a motor comprises a rotor 21, a bearing sleeve 26, a stator 27 surrounding the bearing sleeve 26, and a bearing 24 disposed in the bearing sleeve 26. The bearing 24 defines an annular notch 28 at an end thereof, for receiving the fastener 30 therein. The bearing 24 defines a hole 25, for receiving the shaft 12 therein.

In use of the retaining device 10, an end of the shaft 12 distal from the guide portion 14 is fixed in the rotor 21. The fastener 30 is received in the notch 28 of the bearing 24. The combined shaft 12 and rotor 21 is inserted, guide portion 14 first, into the hole 25 of the bearing 24. The guide portion 14 resiliently expands the fastener 30 until the fastener 30 is snappingly received and secured in the groove 16 of the shaft 12. Thus the fastener 30 securely locks the shaft 12 so that the shaft 12 is prevented from escaping from the bearing 24.

The retaining device 10 of the present invention has the following main advantages. First, the fastener 30 is bent from a single strip of metallic material. The structure of the fastener 30 is very simple. In addition, the fastener 30 is strong, and is resistant to climatic and chemical degradation. Secondly, the fastener 30 has a circular cross section. Therefore, the fastener 30 can distribute force exerted by the shaft 12 more evenly.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A retaining device comprising:
a shaft defining a groove; and
a generally polygonal fastener formed from a single strip of metallic material, the fastener resiliently receivable in the groove of the shaft.

2. The retaining device as claimed in claim 1, wherein the shaft comprises a guide portion at an end thereof.

3. The retaining device as claimed in claim 2, wherein the guide portion is generally hemispherical.

4. The retaining device as claimed in claim 3, wherein the groove is generally annular, and is located adjacent the guide portion.

5. The retaining device as claimed in claim 4, wherein the fastener is formed from a single strip of stainless steel material.

6. The retaining device as claimed in claim 5, wherein the stainless steel material has a circular cross section.

7. The retaining device as claimed in claim 1, wherein the fastener is generally an equilateral triangle.

8. The retaining device as claimed in claim 7, wherein a diameter of a largest imaginary circle that can be drawn inside the fastener is less than a diameter of a main portion of the shaft, but greater than a diameter of the shaft at the groove.

9. The retaining device as claimed in claim 8, wherein the fastener comprises three straight sides, a generally U-shaped resilient portion is formed at a junction of two of the sides, another generally U-shaped resilient portion is formed at a junction of another two of the sides, and a pair of end portions is formed at a junction of a further two of the sides.

10. A motor comprising:
a bearing sleeve;
a stator surrounding the bearing sleeve;
a rotor;
a bearing disposed in the bearing sleeve;
a substantially polygonal fastener bent from a metallic strip, the fastener comprising a plurality of resilient portions formed at junctions of sides of the polygon for providing resilience for the fastener; and
a shaft fixed to the rotor and received in the bearing, the shaft defining a groove at an end thereof, the shaft extending through the fastener and engaging therewith at the groove, whereby the fastener prevents the shaft from escaping from the bearing.

11. The motor as claimed in claim 10, wherein the shaft comprises a guide portion at an end thereof distal from the rotor, for facilitating extension of the shaft through the fastener.

12. The motor as claimed in claim 10, wherein the fastener is bent from a single strip of stainless steel material.

13. The motor as claimed in claim 12, wherein the fastener is generally an equilateral triangle.

14. The motor as claimed in claim 13, wherein a diameter of a largest imaginary circle that can be drawn inside the fastener is less than a diameter of a main portion of the shaft, but greater than a diameter of the shaft at the groove.

15. The motor as claimed in claim 14, wherein the fastener comprises three sides, a generally U-shaped resilient portion is formed at a junction of two of the sides, another generally U-shaped resilient portion is formed at a junction of another two of the sides, and a pair of end portions is formed at a junction of a further two of the sides.

16. The motor as claimed in claim 10, wherein the bearing defines an inner notch, and the fastener is received in the notch.

17. A motor comprising:
a bearing sleeve;
a stator surrounding the bearing sleeve;
a rotor surrounding the stator;
a bearing disposed in the bearing sleeve;
a shaft fixed to the rotor and received in the bearing;
a fastener bent from a wire and circumferentially received in an annular groove of the shaft; wherein
said fastener includes portions with a small radial dimension from the shaft and engaged within the groove, and other portions with a large radial dimension from the shaft and sandwiched between the bearing sleeve and the bearing axially.
